(19) United States
(12) Patent Application Publication
(10) Pub. No.: US 2009/0075521 A1
(43) Pub. Date: Mar. 19, 2009

(54) STACKED ELECTRICAL CONNECTOR STRUCTURE

(75) Inventor: Sheng Zhou, Taoyuan Hsien (TW)

Correspondence Address: J C PATENTS, INC., 4 VENTURE, SUITE 250, IRVINE, CA, 92618, US

(73) Assignee: SPEED TECH CORP., Taoyuan Hsien (TW)

(21) Appl. No.: 11/857,611

(22) Filed: Sep. 19, 2007

(51) Int. Cl. H01R 24/04

(52) U.S. Cl. 439/668

(57) ABSTRACT

A stacked electrical connector structure including secondary electrical connectors stacked together along a direction perpendicular to a circuit board is provided. The stacked electrical connector includes an insulating body, signal terminal sets, groups of transmission terminals and a retaining block. A tail part extends from the end of each of the signal terminals, in which each of the transmission terminals is a blanking terminal and has two finger parts extending towards the tail parts of the signal terminals. The finger parts of each transmission terminal interfere with the tail part of each signal terminal. The retaining block has terminal channels for accommodating and fixing each transmission terminal, and the maximum dimension between two sides of each transmission terminal is slightly larger than the minimum dimension within each terminal channel of the retaining block, thereby fixing the relative position of the transmission terminals and the retaining block.

### BACKGROUND OF THE INVENTION

1. Field of the Invention

The present invention relates to a stacked electrical connector structure, and more particularly to an electrical connector structure applicable for stacking a plurality of electrical connectors in a direction perpendicular to a circuit board.

2. Description of Related Art

Under the trend of maximizing the functions of an electronic device, the electronic device is generally required to have multiple functions and capable of being connected to a larger number of various external electronic devices, thereby increasing the compatibility and extendibility of the electronic device. In order to enable a user to is use the electronic device conveniently, the electronic device is required to have a smaller volume, no matter it is designed to be portable or not. Under the trend of maximizing the functions of the electronic device and miniizing the overall volume, the spaces occupied by each of the components of the electronic device must be reduced as well, and thus, more components may be assembled into the electronic device.

Metal terminals of the electronic device may be manufactured through two ways, namely, a forming terminal and a blanking terminal. The forming terminal cannot be used as a terminal until it is appropriately bent and formed after being cut, such that the surface of the terminal for contacting a butt device is usually not the fracture surface formed during the cutting process. The blanking terminal can be used as a terminal after being cut, such that the surface of the terminal for contacting the butt device is usually the fracture surface formed during the cutting period. The forming terminal is usually more flexible, and it may be deformed elastically under a small stress; on the contrary, the blanking terminal may be deformed less elastically under a large stress.

As for a common stacked electrical connector, for example, as disclosed in U.S. Pat. No. 7,137,851, the forming terminals are used, and such a design is substantially formed by stacking three electrical connectors in a direction perpendicular to the circuit board, thereby saving more space on the circuit board to accommodate other electronic components. As shown in FIG. 11, the stacked connector disclosed in U.S. Pat. No. 7,137,851 mainly consists of a shield housing P1, three caps P2, an insulating body P3, a plurality of terminals P4, and a retaining block P5. The three electrical connectors share the same insulating body P3, so that the three vertically-stacked electrical connectors are integrated into one piece. The plurality of terminals P4 is disposed corresponding to each of the electrical connectors on the insulating body, even when three connectors with substantially the same terminal structure are stacked, the retaining block P5 disclosed in U.S. Pat. No. 7,137,851 needs to be inserted into the insulating body P3 by two glands P51, and thereby preventing a short circuit from occurring to the terminals P4 due to an excessive short distance there-between.

However, the stacked electrical connector disclosed in U.S. Pat. No. 7,137,851 has a defect that it is assembled in an excessive complicated way, that is because the arrangement and height of each of the terminals within the stacked electrical connector cannot be maintained through the retaining block P5 unless the two glands P51 are fitted with each of the terminals and the insulating body first. The whole assembling process of such a design is too complicated and troublesome, so the conventional stacked electrical connector disclosed in U.S. Pat. No. 7,137,851 needs to be improved, thereby increasing the efficiency for assembling a production line.

### SUMMARY OF THE INVENTION

The present invention is mainly directed to a stacked electrical connector structure applicable for stacking a plurality of secondary electrical connectors in a direction perpendicular to a circuit board, and the stacked electrical connector is helpful for assembling a production line.

The present invention is further directed to a stacked electrical connector structure, applicable for stacking a plurality of secondary electrical connectors in a direction perpendicular to a circuit board, and terminals of the stacked electrical connector may be manufactured through a process of saving materials.

As embodied and broadly described herein, the present invention provides a stacked electrical connector structure, which is mainly formed by a plurality of secondary electrical connectors stacked together. The stacked electrical connector includes an insulating body, a plurality of signal terminal sets, a plurality of groups of transmission terminals, and a retaining block. A tail part extends from an end of each of the signal terminals, one end of each of the transmission terminals is electrically connected to the tail part of each of the signal terminals, and the transmission terminals are blanking terminals. The retaining block has a plurality of terminal channels for accommodating and fixing each of the transmission terminals respectively, thereby fixing the retaining block on the insulating body through the interference and cooperation between each of the signal terminals and each of the transmission terminals.

In order to make the aforementioned and other aspects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of an appearance of a first embodiment of the present invention.

FIG. 2 is a perspective view of an appearance of an alternative embodiment of the first embodiment of the present invention.

FIG. 3 is the first exploded perspective view of the first embodiment of the present invention.

FIG. 4 is the second exploded perspective view of the first embodiment of the present invention.

FIG. 5 is a schematic view of the relationship between signal terminals, transmission terminals, and a retaining block according to the first embodiment of the present invention.

FIG. 6 is the first schematic view of assembling the retaining block with the insulating body according to the first embodiment of the present invention.

FIG. 7 is the second schematic view of assembling the retaining block with the insulating body according to the first embodiment of the present invention.

FIG. 8 is the third schematic view of assembling the retaining block with the insulating body according to the first embodiment of the present invention.

FIG. 9 is the fourth schematic view of assembling the retaining block with the insulating body according to the first embodiment of the present invention.

FIG. 10 is the fifth schematic view of assembling the retaining block with the insulating body according to the first embodiment of the present invention.

FIG. 11 is a schematic structural view of U.S. Pat. No. 7,137,851 in the conventional art.

### DESCRIPTION OF EMBODIMENTS

The implementation manner of the present invention is illustrated below through embodiments of the present invention, and persons skilled in the art may understand other advantages and efficacies of the present invention from the disclosure of this specification, thereby deducing other specific embodiments of the present invention.

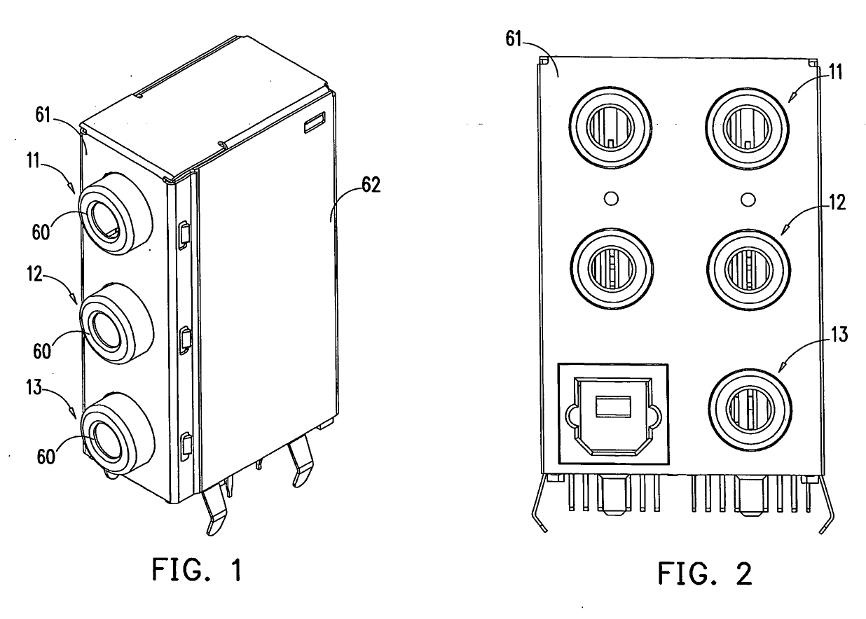

As shown in FIGS. 1 and 2, the technique of the present invention is mainly directed to a stacked electrical connector with a first secondary electrical connector 11, a second secondary electrical connector 12, and a third secondary electrical connector 13 being stacked along a direction perpendicular to a circuit board (not shown). However, such stacking is not limited to stacking in a single row, and the electrical connectors stacked in multiple rows shown in FIG. 2 may also use the technique of the present invention.

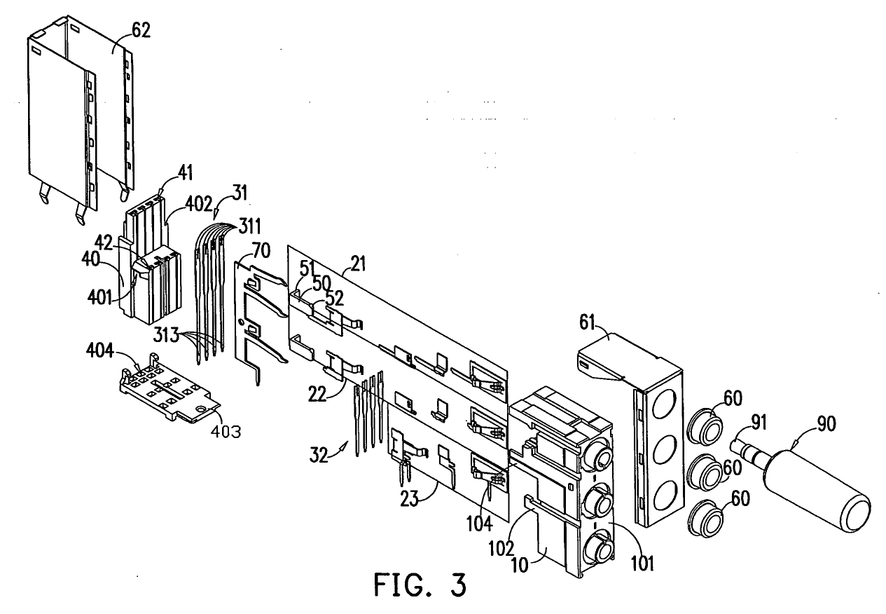

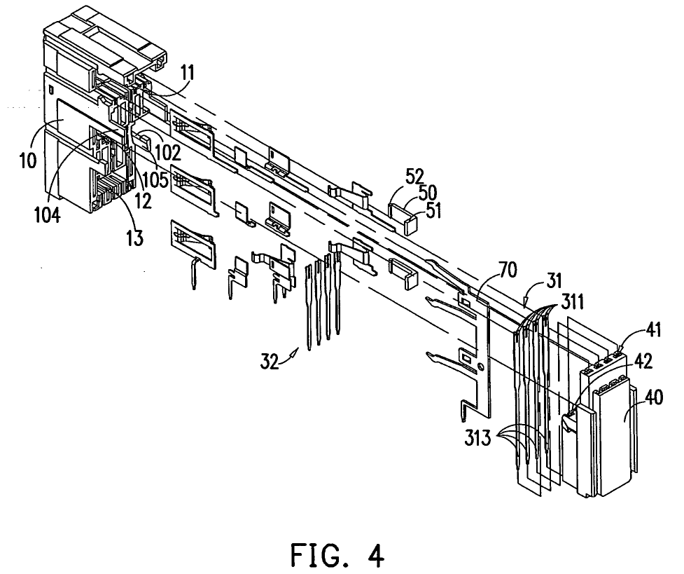

In the embodiment of the present invention as shown in FIGS. 3 and 4, the stacked electrical connector is mainly formed by a front shield housing 61, a rear shield housing 62, three caps 60, an insulating body 10, a plurality of signal terminal sets 21, 22, 23, a plurality of groups of transmission terminals 31 and 32, and a retaining block 40. The front shield housing 61 and the rear shield housing 62 for covering the stacked electrical connector form an anti-electromagnetic interference shield housing, which often covers the external surface of the stacked electrical connector, thereby preventing the external electromagnetic waves from interfering the operation of the electrical connectors. Since the three caps 60 are used as butt terminals 91 for guiding a butt electrical connector 90, in other embodiments, the three caps 60 sometimes may not be separated from the insulating body 10 of the electrical connector, but act as one part of the insulating body. Meanwhile, under the consideration of simplifying the components, the three secondary electrical connectors 11, 12, and 13 may be designed to share the same insulating body 10 and other components that can be shared, such as a ground terminal 70, and they may also be formed by sharing a single component, thereby facilitating the assembling of the production line.

In the technique of the present invention, the configuration that the insulating body 10 has three signal terminal sets 21, 22, and 23 and a plurality of groups of transmission terminals 31 and 32 is designed according to the fact that a plurality of secondary electrical connectors 11, 12, and 13 are stacked in a direction perpendicular to the circuit board in this embodiment. Therefore, in the following illustration, if it is not specially stated herein, only the first secondary electrical connector 11 is selected as an example, and those skilled in the art may appreciate that the other two secondary electrical connectors 12 and 13 have the same or similar structure according to this specification, so as to let the description become less complicated. In the figures of this embodiment, since the third secondary electrical connector 13 is located quite close to the circuit board, if the first secondary electrical connectors 11 and the second secondary electrical connectors 12 divide the terminals into the signal terminal sets 21 and 22 and transmission terminals 31 and 32, the assembling process may not be carried out conveniently. Therefore, in this embodiment, the third secondary electrical connector 13 is only represented by one signal terminal set 23, which does not mean that the technique disclosed in the present invention cannot be implemented in the third secondary electrical connector 13.

A tail part 211 extends from each of the signal terminals 21 of the first secondary electrical connector 11, and the tail part 211 of each of the signal terminals 21 is electrically connected to the corresponding transmission terminals 31 respectively. The butt terminals 91 of the butt connector 90, each of the signal terminals 21, and the circuit board are electrically communicated through an extension section 311 of each of the transmission terminals 31.

In this embodiment, the insulating body 10 further includes a stopper 50, which has a foot part 51 and a hook 52. Due to the hook 52, the stopper 50 may be detachably assembled on the insulating body 10. The foot part 51 of the stopper 50 extends towards one signal terminal 21, and is used to stop the signal terminal 21, thereby reducing the deformation of the signal terminal 21 or preventing the signal terminal 21 from being pushed out of the insulating body 10 while the butt terminals 91 of the butt electrical connector 90 is inserted into the stacked electrical connector. According to the disclosure of the present invention, those skilled in the art may think of a stopper 50 that is integrated with the insulating body 10 and cannot be detached from the insulating body 10, thereby enabling the production line to be assembled more conveniently.

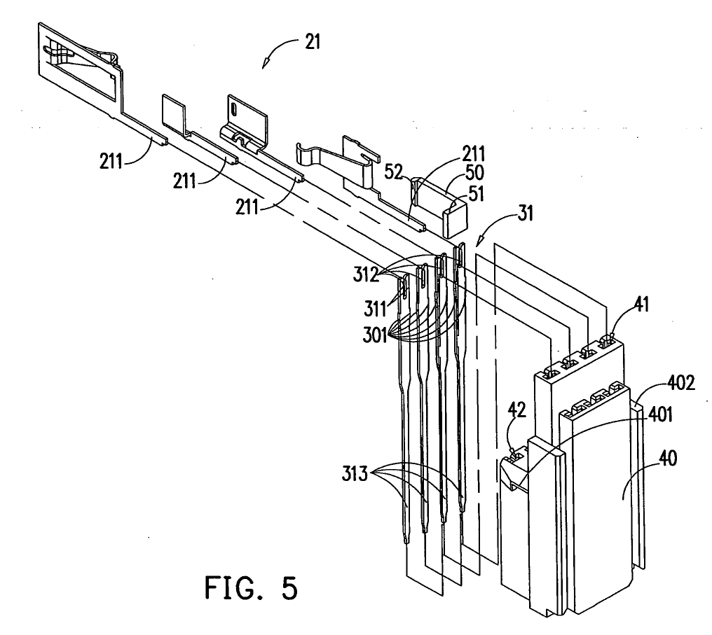

In the embodiment of the present invention as shown in FIG. 5, the retaining block 40 has a plurality of terminal channels 41 and 42, and each of the terminal channels 41 is used to accommodate a transmission terminal 31 to be inserted and fixed therein. In this embodiment, a tooth part 301 extends from each side of each of the transmission terminals, and the maximum dimension of the tooth part 301 is slightly larger than the minimum dimension within the terminal channel 41 of the retaining block 40, so that an interference occurs when the transmission terminals 31 are inserted into the terminal channels 41 of the retaining block 40, and thus retaining the transmission terminals 31 in the terminal channel 41 of the retaining block 40. The retaining block 40 further comprises a base 403, which is detachable from the retaining block 40. There are through holes 404 deployed on said base 403 for each extension section 311 of the transmission terminals 31 penetrated through to electrical connect with a print circuit board.

Each of the transmission terminals 31 in the present invention has a pair of finger parts 311 extending towards the tail parts 211 of each of the signal terminals 21, so that a recess 312 is formed between the two finger parts 311 of each of the transmission terminals 31, and thus, the tail part 211 of each of the signal terminals 21 is clamped in the recess 312 by the finger parts 311. According to the above description of the blanking terminals, each of the transmission terminals 31 is clamped with the tail part 211 of each of the signal terminals 21 by the two finger parts 311. Therefore, each of the transmission terminals 31 belongs to the blanking terminals that contact each of the signal terminals with the fracture surface of the terminals formed after being cut. Since the transmission terminals 31 are blanking terminals, the two finger parts 31 of the transmission terminals 31 exert a large normal force on the tail parts 211 of the signal terminals 21, so that the transmission terminals 31 may not be easily released from the signal terminals 21. Since the transmission terminals 31 may not be easily released from the signal terminals 21, and the signal terminals 21 are fixed within the insulating body 10, the relative position between the insulating body 10 and the retaining block 40 may be fixed indirectly as long as the retaining block 40 interferes with each of the transmission terminals 31 through each of the terminal channels 41.

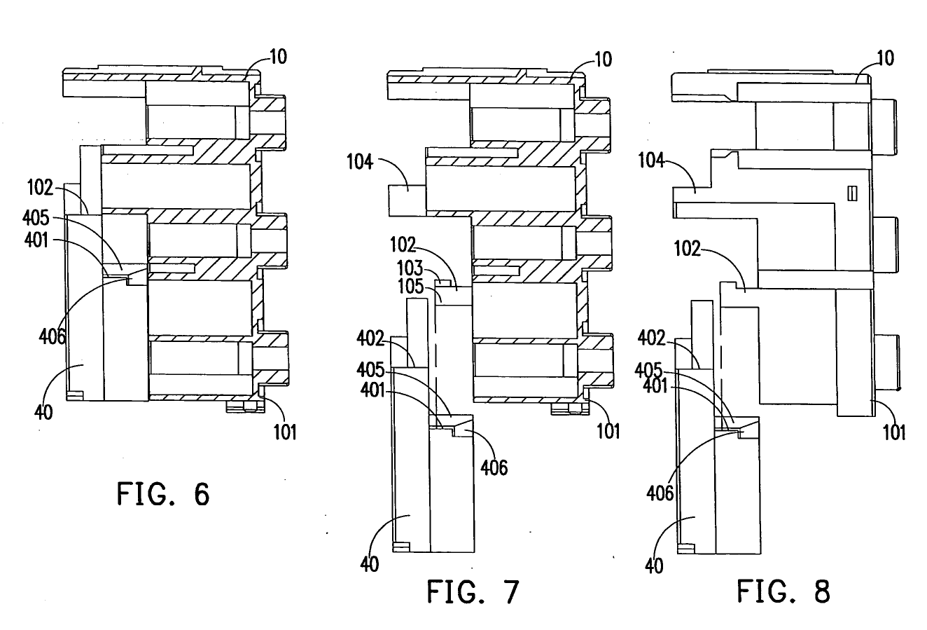

Referring FIGS. 6, 7, and 8, during an assembling process, each of the signal terminals 21 and each of the transmission terminals 31 are firstly mounted in the insulating body 10 and the retaining block 40 respectively. Then, since the cooperation between each of the signal terminals 21 and each of the transmission terminals 31 is achieved by utilizing the two finger parts 311 at one end of each of the transmission terminals 31 to clamp the tail part 211 of each of the signal terminals 21, and each of the transmission terminals 31 is a blanking terminal, the retaining block 40 slides along a surface of the insulating body 10 far away from the bonding surface 101, so as to force the two finger parts 311 of each of the transmission terminals 31 to clamp the tail part 211 of each of the signal terminals 21, i.e., the relative position of the insulating body 10 and the retaining block 40 may be fixed indirectly.

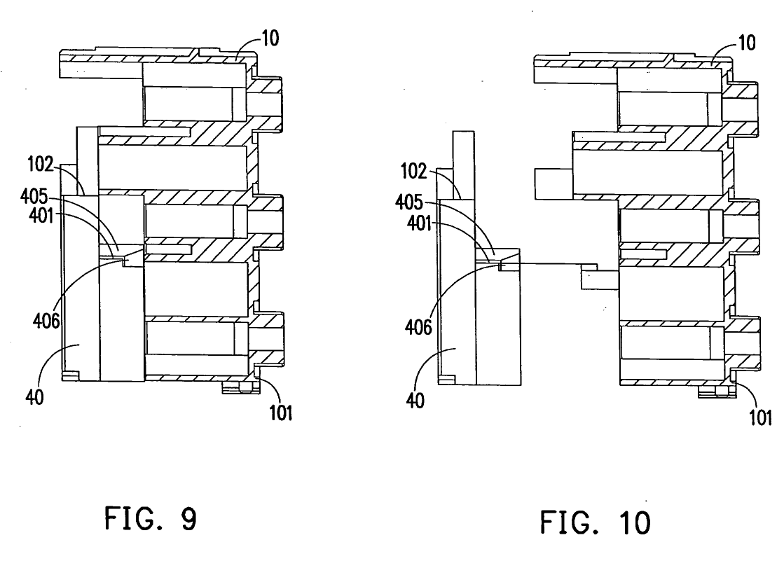

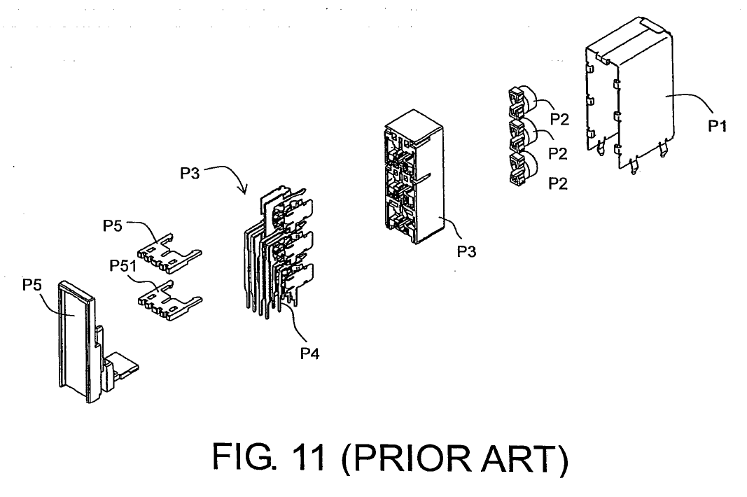

Referring to FIGS. 9 and 10, the technique disclosed in the present invention is not limited to being implemented in the assembling manner described in FIGS. 6, 7, and 8. In the embodiment shown in FIGS. 10 and 11, the retaining block 40 may be fitted with the insulating body 10 without being slid as long as the relative position between each of the transmission terminals 31 and each of the signal terminals 21 is accurate, and the retaining block 40 may also be pressed and forced to be attached to the insulating body 10 tightly, so that each of the transmission terminals 31 fixed in the retaining block 40 is forced to clamp the tail part 211 of each of the signal terminals 21 fixed in the insulating body 10.

Furthermore, in order to assist the process of positioning the retaining block 40 on the insulating body 10, the insulating body 10 has a pair of support arms 102 extending towards the retaining block 40, so as to restrict the retaining block 40 between the pair of support arms 102 of the insulating body 10. In order to further fix the relative position between the retaining block 40 and the insulating body 10, a hook 401 is further disposed on the retaining block 40 for hooking an end portion of one of the support arms 102 for the insulating body 10, thereby retaining the relative position between the retaining block 40 and the insulating body 10. In FIG. 7, a guide ramp 105 is formed at the end of the support arms 102 of the insulating body 10, and used to assist and guide the retaining block 40 to be slid and positioned. Furthermore, the end of the guide ramp 105 of the support arms 102 may be a plane substantially parallel to the external surface of the retaining block 40, thereby clamping and positioning the retaining block 40 appropriately. Those skilled in the art may easily design the plane at the end of the support arms 102 into a configuration of further protruding towards the retaining block 40, thereby further restraining the retaining block by the support arms 102 of the insulating body 10.

In order to make the retaining block 40 to engage with the support arms 102, the retaining block 40 is further having slant lead surfaces 405 and 406, as shown in FIGS. 6 through 8, and those slant lead surfaces 405 and 406, or at least one of the two, are capable to against with the guide ramp 105 of the support arms 102 to lead the retaining block 40 in, during assembling.

The insulating body 10 may further have a pair of cantilevers 104 extending towards the retaining block 40, and the retaining block 40 is disposed with a shoulder 402 corresponding to the pair of cantilevers 104, so as to make the shoulder 402 of the retaining block 40 press against the cantilevers 104 of the insulating body 10, thereby making sure that the retaining block 40 and the insulating body 10 retain correct arrangements or included angles.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stacked electrical connector structure, wherein the stacked electrical connector is a single electrical connector formed by stacking a plurality of secondary electrical connectors together in a direction perpendicular to a circuit board, in which bonding surfaces between each of the secondary electrical connectors and a butt electronic device are substantially the same, the stacked electrical connector comprises an insulating body, a plurality of signal terminal sets, a plurality of groups of transmission terminals, and a retaining block, wherein a tail part extends from an end of each of the signal terminals, each of the transmission terminals corresponding to each of the signal terminals is a blanking terminal and has two finger parts extending towards the tail part of the signal terminal, the finger parts of each of the transmission terminals interfere with the tail part of each of the signal terminals, and one end of each of the transmission terminals far away from the finger parts is electrically connected to the circuit board; and the retaining block has a plurality of terminal channels for accommodating and fixing each of the transmission terminals respectively, and the maximum dimension between two sides of each of the transmission terminals is slightly larger than the minimum dimension within each of the terminal channels of the retaining block, thereby fixing the relative position between the transmission terminals and the retaining block.

2. The stacked electrical connector structure as claimed in claim 1, wherein at least one pair of support arms extends from a surface of the insulating body that is not the bonding surface, the distance between the pair of support arms is slightly smaller than the appearance dimension of the retaining block, and thus, an interference occurs between the insulating body and the retaining block.

3. The stacked electrical connector structure as claimed in claim 2, wherein at least one hook protrudes from the retaining block corresponding to the support arms of the insulating body, such that the retaining block is hooked to one of the support arms via the hook.

4. The stacked electrical connector structure as claimed in claim 2, wherein a bump protrudes from each of the support arms of the insulating body respectively in a direction opposite to each other, such that the insulating body interferes with the retaining body via the two bumps.

5. The stacked electrical connector structure as claimed in claim 1, wherein the retaining block has a shoulder and the insulating body has a cantilever extending towards the shoulder of the retaining block, and thus, the position and arrangement of the retaining block within the insulating body are limited through the cooperation between the cantilever of the insulating body and the shoulder of the retaining block.

6. The stacked electrical connector structure as claimed in claim 1, wherein one end of each of the transmission terminals that is electrically connected to the tail part of each of the signal terminals has two finger parts, and a recess is formed at a central part between the two finger parts of each of the transmission terminals, so as to accommodate the tail part of each of the signal terminals.

7. The stacked electrical connector structure as claimed in claim 1, wherein a part of the retaining block is attached to one surface of the insulating body far away from the bonding surface.

8. The stacked electrical connector structure as claimed in claim 1, wherein each of the transmission terminals has a tooth part, an appearance dimension of each tooth part is slightly larger than the dimension of the corresponding terminal channel of the retaining block, so that an interference occurs between the tooth part of each of the transmission terminals and each of the terminal channels of the retaining block to retain each of the transmission terminals in each of the terminal channels of the retaining block.

9. The stacked electrical connector structure as claimed in claim 1, wherein the insulating body has at least one stopper, and the stopper has a foot part extending towards a specific terminal, thereby enhancing the structural strength of the terminal.

10. The stacked electrical connector structure as claimed in claim 9, wherein the foot part of the stopper extends towards the end of the specific terminal, thereby preventing the specific terminal from dropping off the insulating body when the stacked electrical connector is fitted with a butt electronic device.

11. The stacked electrical connector structure as claimed in claim 1, wherein the retaining block has a detachable base fixed between a bottom surface of the retaining block and the circuit board.
